(19) United States
(12) Patent Application Publication
(10) Pub. No.: US 2014/0030911 A1
(43) Pub. Date: Jan. 30, 2014

(54) ELECTRONIC COMPONENT AND METHOD OF MANUFACTURING THE SAME

(71) Applicant: HOSIDEN CORPORATION, Yao-shi (JP)

(72) Inventors: Takayuki NAGATA, Yao-shi (JP); Daisuke SASAKI, Yao-shi (JP)

(73) Assignee: HOSIDEN CORPORATION, Yao-shi (JP)

(21) Appl. No.: 13/949,636

(22) Filed: Jul. 24, 2013

(30) Foreign Application Priority Data
Jul. 30, 2012 (JP) 2012-168051

(51) Int. Cl. H01R 13/52; H01R 43/00

(52) U.S. Cl. CPC H01R 13/521; H01R 43/005
USPC 439/519; 29/874

(57) ABSTRACT

The invention provides an electronic component including a body having insulation properties, a contact, and a first sealant. The contact includes a fixed portion held by the body and a tail portion projecting out from the body. The first sealant includes non-volatile oil filled in a gap between the fixed portion of the contact and the body.

### CROSS-REFERENCE TO RELATED APPLICATIONS

The present application claims priority under 35 U.S.C. §119 of Japanese Patent Application No. 2012-168051 filed on Jul. 30, 2012, the disclosure of which is expressly incorporated by reference herein in its entity.

### BACKGROUND OF THE INVENTION

1. Technical Field

The present invention relates to waterproof electronic components and methods of manufacturing the electronic components.

2. Background Art

As examples of conventional electronic components of this type, there are a first connector and a second connector as described below.

The first connector includes first and second bodies, a plurality of contacts, and an adhesive. The first body is a tube made of insulating resin, having a front opening and a rear opening. The second body is an insulating cover to close the rear opening of the first body. The contacts each have a fixed portion insert-molded in the second body, a tail portion projecting out of the second body, and a contacting portion received inside the first body. The adhesive is applied to the second body so as to close minute gaps between the second body and the fixed portions of the contacts. This increases waterproofness of the first connector (see paragraphs 0033 to 0035 and FIGS. 6 to 8 of Japanese Patent Application Laid-Open No. 2009-4145).

The second connector includes first and second bodies, a plurality of contacts, and a case. The first body has a plurality of attachment holes. The second body is fixed to the first body so as to close the attachment holes. The second body has a plurality of grooves communicating with the attachment holes. The contacts each have a contacting portion housed in one of the attachment holes of the first body, and a tail portion led to the outside through to one of the groove of the second body. The case is molded integrally with the first and second bodies to close gaps between the contacts and the second body. This increases waterproofness of the second connector (see paragraph 0014 of Japanese Patent Application Laid-Open No. 2012-14863).

### SUMMARY OF INVENTION

Hardened adhesive of the first connector may become deteriorated due to changes in environmental temperature. Particularly, when the first connector is used under a high-temperature environment, there is a possibility that the adhesive deteriorates to an extent that the gaps between the second body and the fixed portions of the contacts are reopened.

On the other hand, the case of the second connector, made of the insulating resin molded integrally with the first and second bodies, is hard to deteriorate due to changes in environmental temperature. However, the case is molded integrally with the first and second bodies so as to cover the first and second bodies, which causes upsizing of the outer size of the second connector.

The present invention is devised in light of the above circumstances. The invention provides electronic components insensitive to changes in environmental temperature and with improved waterproofness without upsizing the outer size. The invention also provides methods of manufacturing the electronic component.

An electronic component according to an aspect of the invention includes a body having insulation properties, a contact, and a first sealant. The contact includes a fixed portion held by the body and a tail portion projecting out from the body. The first sealant includes non-volatile oil filled in a gap between the fixed portion of the contact and the body.

The electronic component of this aspect can prevent ingress of water into the gap between the fixed portion of the contact and the body because the first sealant including non-volatile oil closes the gap. This results in improved waterproofness of the electronic component without upsizing its outer shape. Further advantageously, the first sealant includes oil resistant to deterioration due to changes in environmental temperature, so that the electronic component is insensitive to changes in environmental temperature.

The body may include a first body and a second body fixed to the first body. The fixed portion of the contact may be held by at least the second body. The tail portion of the contact may project out from the second body. The electronic component may further include a second sealant including non-volatile oil. The second sealant may be filled in a gap between the first and second bodies.

The electronic component of this aspect can prevent ingress of water into the gap between the first and second bodies because the second sealant including non-volatile oil closes the gap. This results in improved waterproofness of the electronic component without upsizing its outer shape. Further advantageously, the second sealant includes oil resistant to deterioration due to changes in environmental temperature, so that the electronic component is insensitive to changes in environmental temperature.

The body may include a first body, a second body, and a third body. The first body may have a connection hole, a first fitting hole communicating with the connection hole, and a second fitting hole communicating between the first fitting hole and an outside of the first body. The second fitting hole may be larger or smaller in size than the first fitting hole. The second body may be of an outer shape conforming to a shape of the first fitting hole of the first body. The second body may fit in the first fitting hole. The third body may be of an outer shape conforming to a shape of the second fitting hole of the first body. The third body may fit in the second fitting hole. The fixed portion of the contact may be held by at least the second and third bodies. The tail portion of the contact may project from the third body. The electronic component may further include a second sealant including non-volatile oil. The second sealant may be filled in at least a gap between the first and third bodies.

The electronic component of this aspect can prevent ingress of water into the gap between the first and third bodies because the second sealant including non-volatile oil closes the gap. Further advantageously, the second fitting hole of the first body is larger or smaller in size than the first fitting hole. With the second body fitting in the first fitting hole and the third body fitting in the second fitting hole, the gap between the first and second bodies and the gap between the first and third bodies are not arranged in a straight line. This arrangement reduces the possibility of ingress of water into the connection hole through the gaps. Therefore, the electronic component is further improved in waterproofness. Further advantageously, the second sealant includes oil resistant to deterioration due to changes in environmental temperature, so that the electronic component is insensitive to changes in environmental temperature.

The first sealant may have a contact angle of 90° or larger. In the electronic component of this aspect, the first sealant is improved in water repellency, resulting in further improvement in waterproofness of the electronic component.

The second sealant may have a contact angle of 90° or larger. In the electronic component of this aspect, the second sealant is improved in water repellency, resulting in further improvement in of the electronic component.

The first sealant may have a viscosity of 100 cSt or lower. In the electronic component of this aspect, it is easy to enter the first sealant into the gap by capillary attraction.

The second sealant may have a viscosity of 100 cSt or lower. In the electronic component of this aspect, it is easy to enter the second sealant into the gap by capillary attraction.

The second body may include a fitting portion fitting in the first fitting hole and a projection projecting from the first fitting hole. The third body may include a fitting recess fitting over the projection of the second body.

In the electronic component of this aspect, the projection of the second body fits in the fitting recess of the third body. This arrangement can improve adhesion between the second and third bodies.

A first method of manufacturing an electronic component of the invention includes preparing a body having insulation properties and a contact, the contact including a fixed portion held by the body and a tail portion projecting from the body; and immersing the body and the contact in non-volatile oil and thereby filling the oil into a gap between the fixed portion of the contact and the body.

The first method of manufacturing an electronic component of the invention may include mounting a fixed portion of a contact in the body having insulation properties such that a tail portion of the contact projects from the body; and immersing the body and the contact in non-volatile oil and thereby filling the oil into a gap between the fixed portion of the contact and the body.

The manufacturing method of this aspect makes it possible to fill the oil into the gap between the fixed portion of the contact and the body, simply by immersing the contact and the body in the oil. This method thus eases waterproofing process of the electronic component.

In the case where the body includes a plurality of parts fixed to one another, the method may further include filling the oil also into a gap between the parts when immersing the body and the contact in the oil.

The manufacturing method of this aspect makes it possible to fill the oil into the gap between the parts of the body in addition to the gap between the fixed portion of the contact and the body, simply by immersing the contact and the body in the oil.

A second method of manufacturing an electronic component of the invention includes preparing a body having insulation properties and a contact, the contact including a fixed portion held by the body and a tail portion projecting from the body; and applying non-volatile oil to a gap between the body and the fixed portion of the contact and thereby filling the oil into the gap.

The second method of manufacturing an electronic component of the invention may include mounting a fixed portion of a contact in the body having insulation properties such that a tail portion of the contact projects from the body; and applying non-volatile oil to a gap between the body and the fixed portion of the contact and thereby filling the oil into the gap.

The manufacturing method of this aspect makes it possible to fill the oil into the gap between the body and the fixed portion of the contact simply by applying the oil to the gap. This method thus eases waterproofing process of the electronic component.

In the case where the body includes a plurality of parts fixed to one another, the method may further include applying the oil to a gap between the parts and thereby filling the oil into the gap between the parts before or after applying the oil to the gap between the body and the fixed portion of the contact.

The manufacturing method of this aspect makes it possible to fill the oil into the gap between the parts of the body simply by applying the oil to the gap.

The oil may have a contact angle of 90° or larger. The manufacturing method of this aspect can improve water repellency of the oil, resulting in further improvement in waterproofness of the electronic component

The oil may have a viscosity of 100 cSt or lower. The manufacturing method of this aspect makes it easy to enter the first sealant into the gap by capillary attraction.

The manufacturing method may further include heating or drying the electronic component after filling the oil into the gap. The manufacturing method of this aspect can remove the oil adhered to other parts than the gap of the electronic component by heating or drying.

### BRIEF DESCRIPTION OF DRAWINGS

FIG. 1A is a front, top, and right side perspective view of an electronic component according to a first embodiment of the invention.

FIG. 1B is a back, bottom, and left side perspective view of the electronic component.

FIG. 2A is a cross-sectional view of the electronic component taken along 2A-2A in FIG. 1A.

FIG. 2B is a cross-sectional view of the electronic component taken along the line 2B-2B in FIG. 1A.

FIG. 3A is a cross-sectional view of the electronic component taken along the line 3A-3A in FIG. 1A.

FIG. 3B is a cross-sectional view of the electronic component taken along the line 3B-3B in FIG. 1A.

FIG. 4A is a cross-sectional view of the electronic component taken along the line 4A-4A in FIG. 1A.

FIG. 4B is a cross-sectional view of the electronic component taken along the line 4B-4B in FIG. 1A.

FIG. 5A is an exploded and front, top, and right side perspective view of the electronic component.

FIG. 5B is an exploded and back, top, and left side perspective view of the electronic component.

FIG. 6A is a cross-sectional view, corresponding to FIG. 4A, of an electronic component according to a second embodiment of the invention.

FIG. 6B is a cross-sectional view, corresponding to FIG. 4B, of the electronic component.

### DESCRIPTION OF EMBODIMENTS

The following describes electronic components according to first and second embodiments of the invention.

### Embodiment 1

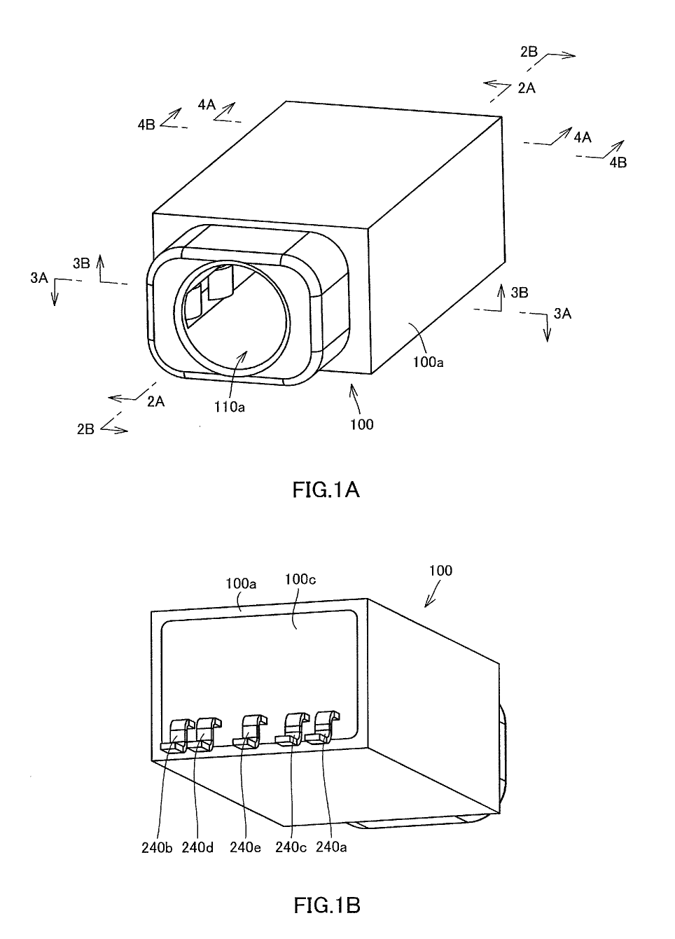

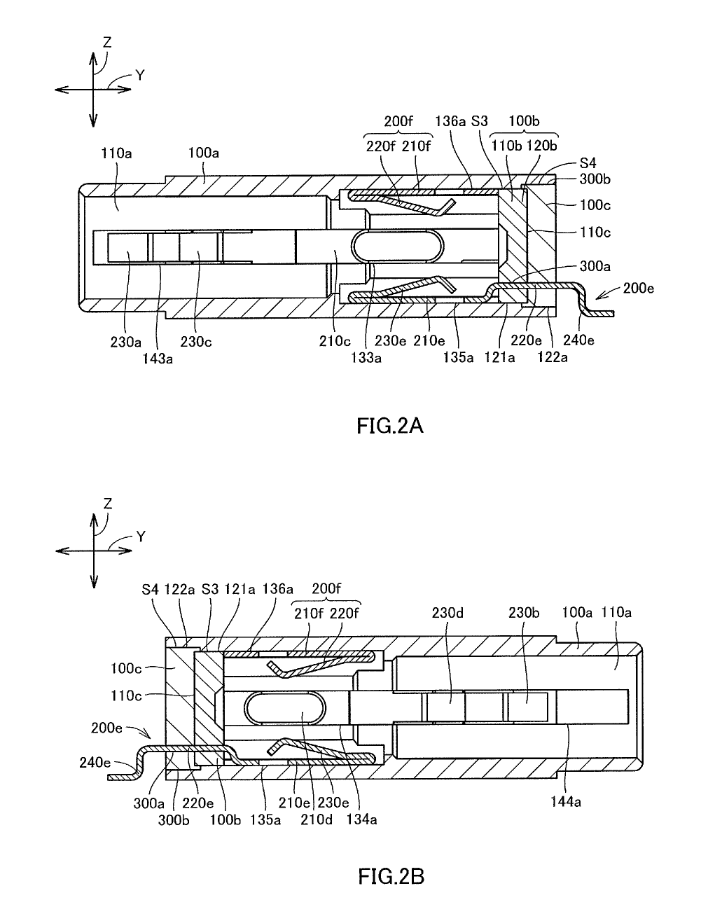

First, the electronic component according to the first embodiment will be described referring to FIGS. 1A to 5B. The electronic component is an audio jack connector connectable to a multipolar connector (mating connector, not shown). This connector includes a body 100; contacts 200a, 200b, 200c, 200d, 200e, and 200f; a plurality of first sealants 300a; and a plurality of second sealants 300b. These components of the connector will be described in detail below. In FIGS. 2A to 3B, and 5A and 5B, Y represents the lengthwise direction of the connector, X represents the widthwise direction of the connector, and Z represents the heightwise direction of the connector.

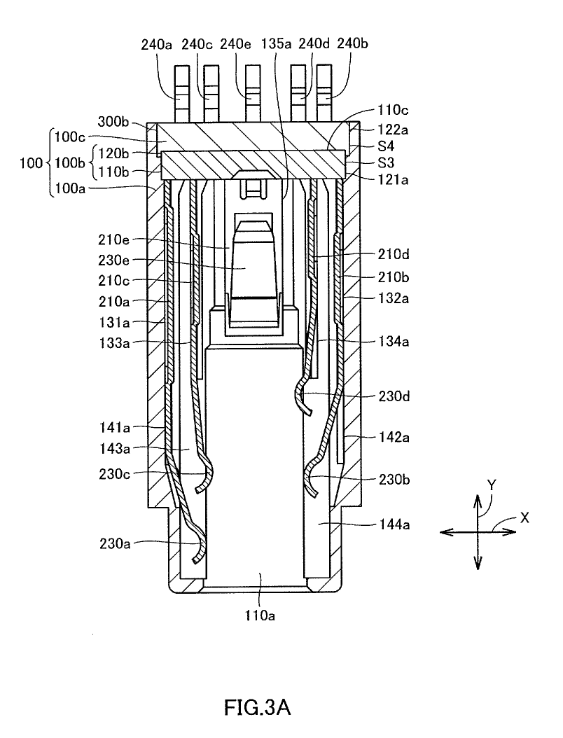

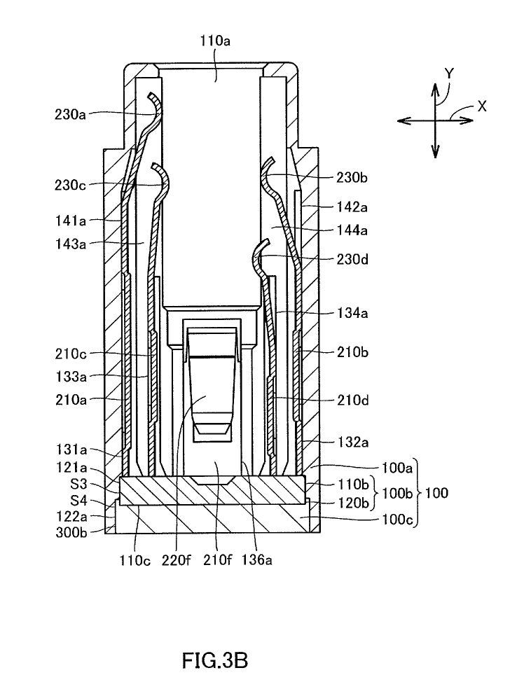

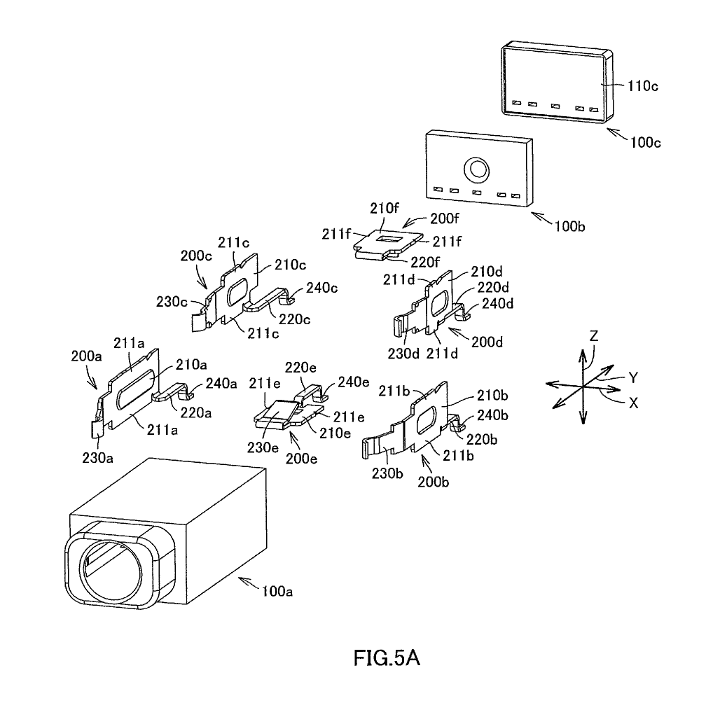

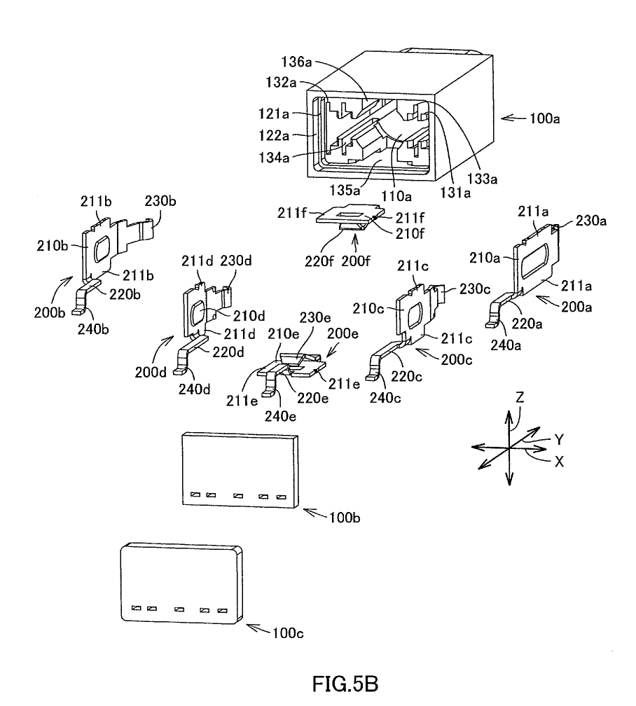

The contact 200a is a press-molded metal plate as shown in FIGS. 3A, 3B, 5A and 5B. The contact 200a includes a first fixed portion 210a, a second fixed portion 220a, a contacting portion 230a, and a tail portion 240a. The first fixed portion 210a is a plate extending in the Y direction, and it has first and second ends in the Y direction and third and fourth ends in the Z direction. The third and fourth ends of the first fixed portion 210a are provided with a pair of engagement pieces 211a.

The contacting portion 230a is a plate continuous with the first end (the front end) of the first fixed portion 210a and extending to one side in the Y direction (forward). The contacting portion 230a is inclined to one side in the X direction (refer to FIGS. 3A and 3B). The distal end of the contacting portion 230a is curved in an arc shape to the one side in the X direction. The second fixed portion 220a is a plate continuous with a portion on the rear side (the other side in the Y direction) of the engagement piece 211a at the fourth end of the first fixed portion 210a. The second fixed portion 220a is bent at a right angle to the first fixed portion 210a to extend to the other side in the Y direction. The tail portion 240a is a generally L-shaped plate continuous with the other side end in the Y direction (the rear end) of the second fixed portion 220a.

The contact 200b is a press-molded metal plate as shown in FIGS. 3A, 3B, 5A and 5B. The contact 200b has substantially the same shape as that of the contact 200a except the following two differences. The first difference is that the contact 200b is shaped symmetrically to the contact 200a. The second difference is that the contact 200b has a first fixed portion 210b that is smaller in the Y direction than the first fixed portion 210a. An engagement piece 211b of the first fixed portion, a second fixed portion 220b, a contacting portion 230b, and a tail portion 240b of the contact 200b are illustrated in FIGS. 2A to 4B.

The contact 200c is a press-molded metal plate as shown in FIGS. 3A, 3B, 5A and 5B. The contact 200c has substantially the same shape as that of the contact 200b except the following two differences. The first difference is that the contact 200c is shaped symmetrically to the contact 200b. The second difference is that the contact 200c has a contacting portion 230c that is inclined to a lesser extent than the contacting portion 230b of the contact 200b (see FIGS. 3A and 3B). An engagement piece 211c of the first fixed portion and a tail portion 240c of the contact 200c are illustrated in FIGS. 2A to 4B.

The contact 200d is a press-molded metal plate as shown in FIGS. 3A, 3B, 5A and 5B. The contact 200d has substantially the same shape as that of the contact 200b except the following two differences. The first difference is that the contact 200d has a first fixed portion 210d that is smaller in the Y direction than the first fixed portion 210b of the contact 200b (see FIGS. 3A and 3B). The second difference is that the contact 200d has a contacting portion 230d that is smaller in the Y direction than the contacting portion 230b of the contact 200b (see FIGS. 3A and 3B). An engagement piece 211d of the first fixed portion, a second fixed portion 220d, and a tail portion 240d of the contact 200d are illustrated in FIGS. 2A to 4B.

The contact 200e is a press-molded metal plate as shown in FIGS. 2A, 2B, 3A, 5A and 5B. The contact 200e includes a first fixed portion 210e, a second fixed portion 220e, a contacting portion 230e, and a tail portion 240e. The first fixed portion 210e is a plate extending in the X direction, and it has first and second ends in the Y direction and third and fourth ends in the X direction. The third and fourth ends of the first fixed portion 210e are provided with a pair of engagement pieces 211e.

The contacting portion 230e is a plate continuous with the first end (the front end) of the first fixed portion 210e and folded back to one side in the Z direction (upward) and to the other side in the Y direction (the rear side). The distal end of the contacting portion 230e is bent to other side in the Z direction (downward). The second fixed portion 220e is a plate continuous with the second end (the rear end) of the first fixed portion 210e, and it is bent to the one side in the Z direction (upward) to extend to the other side in the Y direction. The tail portion 240e is a generally L-shaped plate continuous with the other side end in the Y direction (the rear end) of the second fixed portion 220e.

The contact 200f is a press-molded metal plate as shown in FIGS. 2A, 2B, 3A, 5A and 5B. The contact 200f includes a fixed portion 210f and a contacting portion 220f. The fixed portion 210f is a plate extending in the X direction, and it has first and second ends in the Y direction and third and fourth ends in the X direction. The third and fourth ends of the fixed portion 210f are provided with a pair of engagement pieces 211f. The contacting portion 220f is a plate continuous with the first end (the front end) of the first fixed portion 210f and folded back to the other side in the Z direction (downward) and to the other side in the Y direction (the rear side). The distal end of the contacting portion 220f is bent to the one side in the Z direction (upward).

As shown in FIGS. 2A to 5B, the body 100 includes a first body 100a (a part), a second body 100b (a part), and a third body 100c (a part), which are fixed to one another.

As shown in FIGS. 2A to 5B, the second body 100b is a generally rectangular plate of insulating resin, which may be nylon such as 46 nylon. The second body 100b has an outer shape conforming to the shape of a first fitting hole 121a (to be described) of the first body 100a. The second body 100b is of thicknesswise dimension (the dimension in the Y direction) larger than the depth (the dimension in the Y direction) of the first fitting hole 121a. The second body 100b has a fitting portion 110b and a projection 120b.

As shown in FIGS. 2A to 5B, the third body 100c is a generally rectangular plate of insulating resin, which may be nylon such as 46 nylon. The third body 100c has larger outer size than the second body 100b, and it has a conforming shape to the shape of a second fitting hole 122a (to be described) of the first body 100a. The third body 100c has a fitting recess 110c of shape conforming to the outer shape of the second body 100b. The fitting recess 110c fits over the projection 120b of the second body 100b.

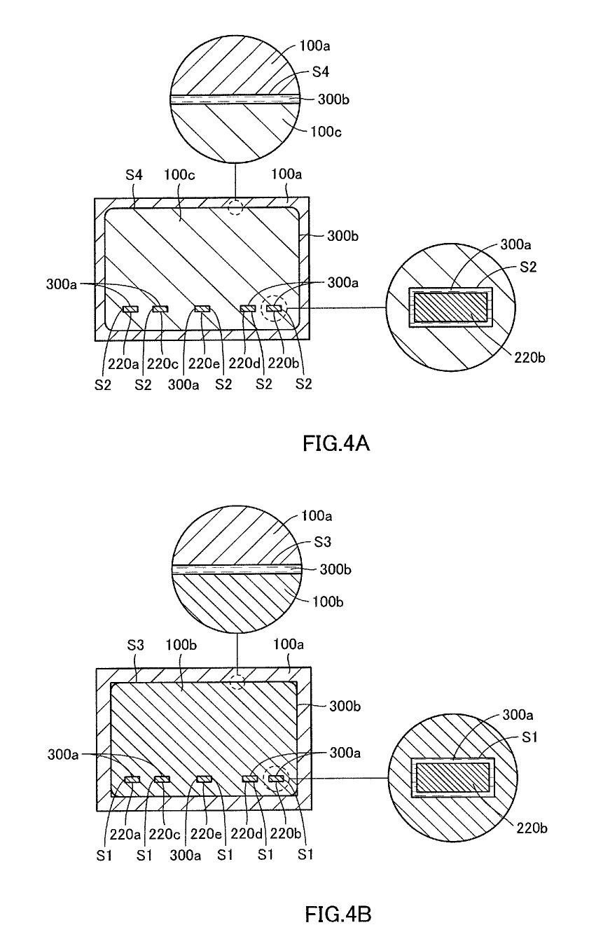

As shown in FIGS. 4A and 4B, embedded in the second and third bodies 100b, 100c are the second fixed portions 220a, 220c, 220e, 220d, 220b of the contacts 200a, 200c, 200e, 200d, 200b in this order in spaced relation to one another along the X direction. In other words, the second and third bodies 100b, 100c hold the second fixed portions 220a, 220c, 220e, 220d, 220b in spaced relation to one another along the X direction. There are minute gaps S1 of 10 μm or narrower between the second body 100b and the respective second fixed portions 220a, 220c, 220e, 220d, 220b. There are minute gaps S2 of 10 μm or narrower between the third body 100c and the respective second fixed portions 220a, 220c, 220e, 220d, 220b. The second fixed portions 220a-220e correspond to the fixed portion of the contact as defined in the claims.

The gaps S1, S2 are filled with the first sealants 300a. The first sealants 300a are of non-volatile oil such as silicone oil. The first sealants 300a each have a contact angle of 90° or larger. The first sealants 300a each have a viscosity within the range of 5 cSt to 100 cSt.

As shown in FIGS. 1A to 5B, the first body 100a is a generally rectangular tube of insulating resin, which may be nylon such as 46 nylon. The first body 100a has a connection hole 110a, the first and second fitting holes 121a, 122a, housing grooves 131a, 132a, 133a, 134a, 135a, 136a, and housing holes 141a, 142a, 143a, 144a.

The combination of the connection hole 110a and the first and second fitting holes 121a, 122a passes through the first body 100a in the Y direction. The connection hole 110a is a substantially columnar hole extending in the center of the first body 100a along the Y direction. The connection hole 110a is adapted to removably receive a multipolar connector. The connection hole 110a is open to the one side in the Y direction.

The first fitting hole 121a is a substantially rectangular hole formed in the first body 100a, in communication with and on the other side in the Y direction of the connection hole 110a. The second fitting hole 122a is a substantially rectangular hole formed in the first body 100a, on the other side in the Y direction of the first fitting hole 121a. The second fitting hole 122a has larger outer size than the size of the first fitting hole 121a. The second fitting hole 122a communicates with the first fitting hole 121a and is open to the other side in the Y direction. In other words, the second fitting hole 122a communicates between the first fitting hole 121a and the outside of the first body 100a.

The first fitting hole 121a fits over the fitting portion 110b of the second body 100b. The second fitting hole 122a fits over the third body 100c. The projection 120b of the second body 100b projects from the first fitting hole 121a to the other side in the Y direction to fit in the fitting recess 110c of the third body 100c as mentioned above. This is how the first, second and third bodies 100a, 100b, 100c are fixed to one another. As shown in FIG. 4B, there is a minute gap S3 of 10 μm or narrower between the second body 100b and the walls of the first fitting hole 121a of the first body 100a. As shown in FIG. 4A, there is a minute gap S4 of 10 μm or narrower between the third body 100c and the walls of the second fitting hole 122a of the first body 100a.

The gaps S3, S4 are filled with the second sealants 300b. The second sealants 300b are of non-volatile oil such as silicone oil. The second sealants 300b each have a contact angle of 90° or larger. The second sealants 300b each have a viscosity within the range of 5 cSt to 100 cSt.

The housing groove 136a is provided on the one side in the Z direction (on the upper side) of the connection hole 110a of the first body 100a as shown in FIGS. 2A, 2B, 3B and 5B. The housing groove 136a communicates with the connection hole 110a. The housing groove 136a h has a slightly smaller dimension in the X direction than that of the fixed portion 210f of the contact 200f including the engagement pieces 211f. The fixed portion 210f of the contact 200f is press-fitted securely in the housing groove 136a. The distal portion of the contacting portion 220f is located inside the connection hole 110a.

The housing groove 135a is provided on the other side in the Z direction (on the lower side) of the connection hole 110a of the first body 100a as shown in FIGS. 2A, 2B, 3B and 5B. The housing groove 135a communicates with the connection hole 110a. The housing groove 135a has a slightly smaller dimension in the X direction than that of the first fixed portion 210e of the contact 200e including the engagement pieces 211e. The first fixed portion 210e of the contact 200e is press-fitted securely in the housing groove 135a. The distal portion of the contacting portion 230e is located inside the connection hole 110a.

The housing groove 134a is provided on the one side in the X direction (on the right side in FIG. 3A) of the connection hole 110a of the first body 100a as shown in FIGS. 3A, 3B, and 5B. The housing groove 134a communicates with the connection hole 110a. The housing groove 134a has a slightly smaller dimension in the Z direction than that of the first fixed portion 210d of the contact 200d including the engagement pieces 211d. The first fixed portion 210d of the contact 200d is press-fitted securely in the housing groove 134a.

The housing hole 144a is provided on the one side in the Y direction (on the front side) of the housing groove 134a of the first body 100a as shown in FIGS. 3A and 3B. The housing hole 144a communicates with the housing groove 134a and the connection hole 110a. The housing hole 144a houses the contacting portion 230d of the contact 200d. The distal portion of the contacting portion 230d is located inside the connection hole 110a.

The housing groove 133a is provided on the other side in the X direction (on the left side in FIG. 3A) of the connection hole 110a of the first body 100a as shown in FIGS. 3A, 3B and 5B. The housing groove 133a communicates with the connection hole 110a. The housing groove 133a has a slightly smaller dimension in the Z direction than that of the first fixed portion 210c of the contact 200c including the engagement pieces 211c. The first fixed portion 210c of the contact 200c is press-fitted securely in the housing groove 133a.

The housing hole 143a is provided on the one side in the Y direction (on the front side) of the housing groove 133a of the first body 100a as shown in FIGS. 3A and 3B. The housing hole 143a communicates with the housing groove 133a and the connection hole 110a. The housing hole 143a houses the contacting portion 230c of the contact 200c. The distal portion of the contacting portion 230c is located inside the connection hole 110a.

The housing groove 132a is provided on the one side in the X direction (on the right side in FIG. 3A) of the housing groove 134a of the first body 100a as shown in FIGS. 3A, 3B, and 5B. The housing groove 132a communicates with the housing groove 134a. The housing groove 132a has a slightly smaller dimension in the Z direction than that of the first fixed portion 210b of the contact 200b including the engagement pieces 211b. The first fixed portion 210b of the contact 200b is press-fitted securely in the housing groove 132a.

The housing hole 142a is provided on the one side in the Y direction (on the front side) of the housing groove 132a of the first body 100a as shown in FIGS. 3A and 3B. The housing hole 142a communicates with the housing groove 132a, the housing groove 134a, the housing hole 144a, and the connection hole 110a. The contacting portion 230b of the contact 200b is received in the housing hole 142a and the housing hole 144a. The distal portion of the contacting portion 230b is located on the one side in the Y direction (on the front side) of the contacting portion 230d inside the connection hole 110a. The contacting portion 230b and the contacting portion 230c are opposed to each other.

The housing groove 131a is provided on the other side in the X direction (on the left side in FIG. 3A) of the housing groove 133a of the first body 100a as shown in FIGS. 3A, 3B and 5B. The housing groove 131a communicates with the housing groove 133a. The housing groove 131a has a slightly smaller dimension in the Z direction than the first fixed portion 210a of the contact 200a including the engagement pieces 211a. The first fixed portion 210a of the contact 200a is press-fitted securely in the housing groove 131a.

The housing hole 141a is provided on the one side in the Y direction (on the front side) of the housing groove 131a of the first body 100a as shown in FIGS. 3A and 3B. The housing hole 141a communicates with the housing groove 131a, the housing groove 133a, the housing hole 143a, and the connection hole 110a. The contacting portion 230a of the contact 200a is received in the housing hole 141a and the housing hole 143a. The distal portion of the contacting portion 230a is located on the one side in the Y direction (on the front side) of the contacting portion 230c inside the connection hole 110a.

The connector configured as describe above may be fabricated in the following manner. The first step is to prepare the first body 100a formed by injection-molding insulating resin. Also prepared is the contact 200f by stamping a metal plate. The fixed portion 210f of the contact 200f is press-fitted in the housing groove 136a of the first body 100a. The fixed portion 210f is thus held in the housing groove 136a, and the distal portion of the contacting portion 220f of the contact 200f is located inside the connection hole 110a of the first body 100a.

Also prepared are the contacts 200a to 200e by stamping a metal plate. The front portions of the second fixed portions 220a, 220c, 220e, 220d, 220b of the contacts 200a, 200c, 200e, 200d, 200b are put in a first die (not shown) and arranged in spaced relation to one another along the X direction in the foregoing order. The next step is to inject insulating resin into the first die to insert-mold the front portions of the second fixed portions 220a, 220c, 220e, 220d, 220b in the insulating resin. The hardened insulating resin forms the second body 100b. The front portions of the second fixed portions 220a, 220c, 220e, 220d, 220b are embedded in the second body 100b in spaced relation to one another and in this order along the X direction. At this point, the gaps S1 are left between the second body 100b and the respective second fixed portions 220a, 220c, 220e, 220d, 220b.

Thereafter, the first fixed portions 210a-210e of the contacts 200a-200e are press-fitted in the housing grooves 131a-135a of the first body 100a, and the second body 100b is fitted in the first fitting hole 121a of the first body 100a. At this point, the contacting portion 230a of the contact 200a passes through the housing groove 131a and the housing groove 133a to be placed inside the housing hole 141a and the housing hole 143a, and the distal portion of the contacting portion 230a passes through the housing groove 131a, the housing groove 133a, the housing hole 141a and the housing hole 143a to be placed inside the connection hole 110a. The contacting portion 230b of the contact 200b passes through the housing groove 132a and the housing groove 134a to be placed inside the housing hole 142a and the housing hole 144a, and the distal portion of the contacting portion 230b passes through the housing groove 132a, the housing groove 134a, the housing hole 142a and the housing hole 144a to be placed inside the connection hole 110a. The contacting portion 230c of the contact 200c passes through the housing groove 133a to be placed inside the housing hole 143a, and the distal portion of the contacting portion 230c passes through the housing groove 133a and the housing hole 143a to be placed inside the connection hole 110a. The contacting portion 230d of the contact 200d passes through the housing groove 134a to be placed inside the housing hole 144a, and the distal portion of the contacting portion 230d passes through the housing groove 134a and the housing hole 144a to be placed inside the connection hole 110a. The contacting portion 230e of the contact 200e is placed inside the connection hole 110a. When the second body 100b fits in the first fitting hole 121a of the first body 100a, the gap S3 is left between the first body 100a and the second body 100b.

The next step is to put the first and second bodies 100a, 100b and the contacts 200a to 200f into a second die (not shown) and inject insulating resin into the second fitting hole 122a of the first body 100a, so that intermediate portions of the second fixed portions 220a, 220c, 220e, 220d, 220b are insert-molded in the insulating resin. The hardened insulating resin forms the third body 100c fitting in the second fitting hole 122a. On the other hand, the projection 120b of the second body 100b fits in the fitting recess 110c of the third body 100c. The intermediate portions of the second fixed portions 220a, 220c, 220e, 220d, 220b are embedded in the third body 100c in spaced relation to one another and in this order along the X direction. The tail portions 240a, 240c, 240e, 240d, 240b project from the third body 100c. At this point, the gaps S2 are left between the third body 100c and the respective second fixed portions 220a, 220c, 220e, 220d, 220b, and the gap S4 is left between the first body 100a and the third body 100c. These are the steps of preparing the body 100 and the contacts 200a to 200f held in the body 100.

The next step is to immerse the rear end portion of the body 100 (i.e., the third body 100c and the wall of the second fitting hole 122a of the first body 100a) and the tail portions 240a-240e of the contacts 200a-200e in non-volatile oil having a contact angle of 90° or larger and a viscosity of 5 cSt to 100 cSt. Consequently, the oil is drawn by capillary attraction into the gaps S1 to S4 to fill the gaps. An alternative step is to apply the oil to the edges of the gaps S2 of the third body 100c and to the edges of the gap S4 between the first body 100a and the third body 100c. The oil may alternatively applied to the edge of the gap S4 and then to the edges of the gaps S2. In either way, the oil is drawn by capillary attraction into the gaps S1 to S4 to fill the gaps. The oil filled in the gaps S1 and S2 forms the first sealants 300a, and the oil filled in the gaps S3 and S4 forms the second sealants 300b. The immersion or the application of the oil may generate an insulating layer on each of the tail portions 240a to 240e. However, the insulating layer is very thin because of low viscosity of the oil as described above. Therefore, the insulating layer would not seriously affect the contact resistance and solderability of the tail portions 240a to 240e.

The above-described electronic component has at least the following technical advantages. First, the gaps S1 and S2 are filled with the first sealants 300a, and the gaps S3, S4 are filled with the second sealants 300b. The first and second sealants 300a, 300b, because of their water repellency, can prevent water ingress into the connection hole 110a through the gaps S1 to S4. Second, the second fixed portions 210a-220e of the contacts 200a-200e are embedded in the second and third bodies 100b, 100c by insert molding. This process leaves only the minute gaps S1 between the second body 100b and the second fixed portions 220a-220e and the minute gaps S2 between the third body 100c and the second fixed portions 220a to 220e. The gap S3 between the first body 100a and the second body 100b and the gap S4 between the first body 100a and the third body 100c are also minute because the second body 100b fits in the first fitting hole 121a of the first body 100a and the third body 100c fits in the second fitting hole 122a. The minuteness of the gaps S1 to S4 also contributes to the resistance to water ingress into the connection hole 110a through the gaps S1 to S4. Furthermore, the second fitting hole 122a of the first body 100a is larger in size than the first fitting hole 121a, the third body 100c fits in the second fitting hole 122a, and the second body 100b fits in the first fitting hole 121a. This arrangement means that the gaps S3 and S4 are not arranged in a straight line in the Y direction. This respect also contributes to the resistance to water ingress into the connection hole 110a through the gaps S3, S4.

Further advantageously, the first and second sealants 300a, 300b made of oil are filled in the gaps S1 to S4, making it possible to improve waterproofness of the electronic component without upsizing outer size of the electric component. Moreover, the first and second sealants 300a, 300b are made of oil resistant to deterioration due to changes in environmental temperature, so that the electronic component is insensitive to changes in environmental temperature.

### Embodiment 2

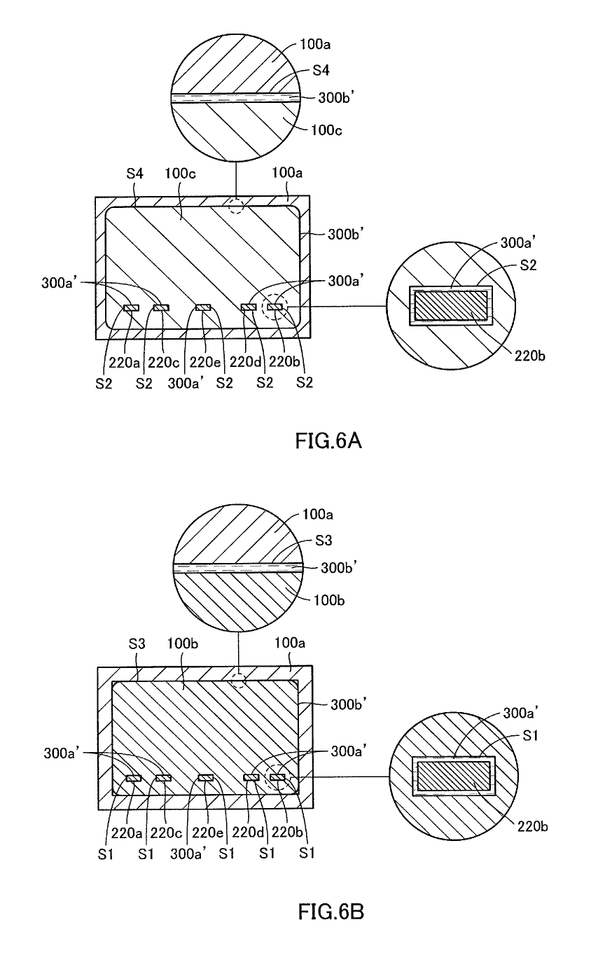

Next, an electronic component according to a second embodiment will be described referring to FIGS. 6A to 6B. The electronic component of the second embodiment has substantially the same configuration as that of the first embodiment, except for first and second sealants 300a′, 300b′ having different configurations from the first and second sealants 300a, 300b. The different points only will be discussed in detail to avoid overlapping descriptions. The first and second sealants of the second embodiment will be referred to with a symbol _′_ added to their reference numerals for the sake of distinction from the first and second sealants 300a, 300b of the first embodiment.

The first sealants 300a′ are non-volatile oil having a contact angle 90° or larger and a viscosity within the range of 5 cSt to 100 cSt, and they are filled in the gaps S1, S2 and then heated or dried. The second sealants 300b′ are also non-volatile oil having a contact angle 90° or large and a viscosity within the range of 5 cSt to 100 cSt, but they are filled in the gaps S3, S4 and then heated or dried.

The viscosity of the first and second sealants 300a′, 300b′ hardly varies even when they are heated or dried. Some methods for the heating or the drying may increase the viscosity of the first and second sealants 300a′, 300b′ and turn them into gel or coating.

The first, second, third bodies 100a, 100b, 100c are made of insulating resin such as nylon as described above and therefore are resistant to heat. Therefore, the first, second, and third bodies 100a, 100b, 100c are suitable for use with the first and second sealants 300a′, 300b′ to be heated or dried.

The above-described electronic component may be manufactured in similar steps to those for the electronic component of the first embodiment. The difference is that after filling the above-described oil into the gaps S1 to S4, the electronic component is heated at 160° for about one hour or air-dried for twenty-four hours. This treatment removes the oil adhered to other portions than the gaps S1 to S4 of the electronic component (e.g., the oil adhered to the tail portions 240a to 240e). The oil filled in the gaps S1, S2 and heated or dried forms the first sealants 300a′. The oil filled in the gaps S3, S4 and heated or dried forms the second sealants 300b′. The first sealants 300a′ existing inside the gaps S1, S2 and the second sealants 300′ existing inside the gaps S3, S4 will not be removed by heating or drying, unlike the oil adhered to the other portions than the gaps S1 to S4 of the electronic component.

The above-described electronic component can provide similar effects to those of the electronic component of the first embodiment. In addition, the heating or drying treatment removes the oil adhered to the other portions than the gaps S1 to S4 of the electronic component, eliminating the possibility that the oil adversely affects electric characteristics of the electronic component.

The invention is not limited to the electronic components and their manufacturing methods according to the first and second embodiments described above. The electronic components and their manufacturing methods may be modified in any manner within the scope of claims. Specific modifications will be described in detail below.

The first sealants 300a of the above-described first embodiment are non-volatile oil having a contact angle of 90° or larger and a viscosity of 5 cSt to 100 cSt, and they are filled in the gaps S1 and S2. The first sealants 300a′ of the above-described second embodiment are non-volatile oil having a contact angle 90° or larger and a viscosity of 5 cSt to 100 cSt, and they are filled in the gaps S1, S2 and then heated or dried. However, the first sealants of the invention can be modified in any manner as long as they are non-volatile oil filled in the gaps between the fixed portions of the contacts and the body. For example, the first sealants may be provided only in the gaps S2. In the case where the third body is omitted, the first sealants may be provided only in the gaps S1. Further, the first sealants may include oil having a contact angle of 90° or larger and a viscosity of 100 cSt or higher, or oil having a contact angle of 90° or smaller and the viscosity of 100 cSt or lower, or oil having a contact angle of 90° or smaller and a viscosity of 100 cSt or higher.

The second sealants 300b of the first embodiment are non-volatile oil having a contact angle of 90° or larger and a viscosity of 5 cSt to 100 cSt, and they are filled in the gaps S3 and S4. The second sealants 300b′ of the second embodiment are non-volatile oil having a contact angle 90° or large and a viscosity of 5 cSt to 100 cSt, and they are filled in the gaps S3, S4 and then heated or dried. However, the second sealants of the invention can be modified as follows. In the case where the body is made of one part, the second sealants may be omitted. Alternatively, the second sealants can be modified to non-volatile oil filled in the gap between the first and second bodies, or in the gap between the first and third bodies. Specifically, the second sealant may be provided only in the gap S4. Moreover, in the case where the third body 100c is omitted, the second sealant 300b may be provided only in the gap S3. Further, the second sealants may include oil having a contact angle of 90° or larger and a viscosity of 100 cSt or higher, or oil having a contact angle of 90° or smaller and a viscosity of 100 cSt or lower, or oil having a contact angle of 90° or smaller and a viscosity of 100 cSt or higher.

The body 100 of the first and second embodiments consists of the first, second and third bodies 100a, 100b, 100c (i.e. a plurality of parts) fixed to one another. However, the body can be modified in any manner as long as it has insulating properties and is adapted to hold fixed portions of the contacts. That is, the body only required to have at least one part having insulating properties. Also, the body may have a connection hole to fit therein a connection portion of a mating connector, or a connection portion to fit in a connection hole of a mating connector, and a holding portion to hold the fixed portions of the contacts. Alternatively, the body can be configured such that a portion or an outer circumference of the body is covered with a shield case. The shield case may be a press-molded metal plate, or may be made of insulating resin with vapor-deposited metal on its outer surface. The body may have a plurality of parts also in the case where the body is covered with a shield case.

The first body 100a of the invention is not limited to the configurations of the first and second embodiments and the above-described modifications having the connection hole 110a, the first and second fitting holes 121a, 122a, the housing grooves 131a, 132a, 133a, 134a, 135a, 136a, and the housing holes 141a, 142a, 143a, 144a. For example, the first body of the invention may have the connection hole or the connection portion, and the holding portion as described in the preceding paragraph. In this case, the second and third bodies can be omitted. Moreover, the first body may have the connection hole or the connection portion only. That is, the first body may not be adapted to hold the fixed portions of the contacts. In this case, the second body and/or the third body may be configured to hold the fixed portions of the contacts. The third body can be omitted in the case where the first and second bodies hold the fixed portions of the contacts, or in the case where only the second body holds the fixed portions of the contacts.

The second body 100b of the first and second embodiments and the above-described modifications fits in the first fitting hole 121a of the first body 100a. However, the second body can be modified in any manner as long as it is an insulating resin body fixed to the first body. For example, the second body can may a block or tube made of insulating resin fixed to the first body.

The third body 100c of the first and second embodiments and the above-described modifications fits in the second fitting hole 122a of the first body 100a. However, the third body can be modified in any manner as long as it is an insulating resin body fixed to the first or second body. For example, the third body may be a block or tube made of insulating resin fixed to the first body and/or the second body.

The third body 100c of the first and second embodiments and the above-described modifications is larger in outer size than the second body 100b. However, the second and third bodies are not limited thereto. For example, the second and third bodies may have the same outer size. The second body may be larger in outer size than the third body. In this case, the first fitting hole of the first body may be larger in size than the second fitting hole.

The contacts 200a to 200e of the first and second embodiments and the above-described modifications, have the first fixed portions 210a to 210e, the second fixed portions 220a to 220e, the contacting portions 230a to 230e, and the tail portions 240a to 240e. However, the contacts of the invention can be modified in any manner as long as they each have a fixed portion held in the body and a tail portion projecting outside the body. That is, the invention requires at least one fixed portion for each contact. In the case where the body has first and second bodies fixed to each other, the fixed portions may be embedded in the first body and/or the second body by insert molding. Alternatively, the fixed portions may be press-fitted securely in press-fitting holes or press-fitting grooves of the first body and/or the second body. In the case where the body has first, second and third bodies fixed to one another, the fixed portions may be embedded in the first body, the second body and/or the third body by insert molding. Alternatively, the fixed portions maybe be press-fitted securely in press-fitting holes or press-fitting grooves of the first body, the second body, and/or the third body. The contacts 200e can be omitted.

The first fixed portions 210a to 210e of the first and second embodiments and the above-described modifications are press-fitted securely in the housing grooves 131a to 135a of the first body 100a. However, the first fixed portions of the invention can be modified in any manner as long as they are held in the first body. For example, the first fixed portions may be embedded in the first body by insert molding. On the other hand, the second fixed portions 220a to 220e of the first and second embodiments and the above-described modifications are embedded in the second and third bodies 100b, 100c. However, the second fixed portions of the invention can be modified in any manner as long as they are held in the second body and/or the third body. For example, the second fixed portions may be press-fitted securely in housing grooves of the second body and/or of the third body. In the case where the second fixed portions are held in either one of the second and third bodies, it is possible to omit the other body.

The contacting portions 230a to 230e of the first and second embodiments and the above-described modifications are housed in the housing holes 141a to 145a of the first body 100a, and the distal portions of the contacting portions 230a to 230e are arranged inside the connection hole 110a. However, the contacting portions may be modified in any manner as long as they are partly located in the connection hole of the body or are provided in the connection portion so as to partly exposed therefrom.

The tail portions 240a to 240e of the first and second embodiments and the modifications each have a generally L shape projecting from the third body 100c. However, the tail portions of the invention can be modified in any manner as long as they project out from the body. For example, the tail portions may extend in line with the respective fixed portions. Alternatively, the tail portions may each be bent at a right angle to each of the fixed portions to hang down.

The electronic component of the first and second embodiments and the modifications is an audio jack connector. However, the electronic component of the invention is applicable to any electronic component including a body, a contact and a first sealant as defined in claim 1. For example, the electronic component is applicable to a connector other than an audio jack connector, a jack, a switch, or the like. The applicable connector may be a USB connector, an HDMI connector, an optical connector, an IC card connector, or the like. The applicable jack may be a modular jack, a power supply jack, or the like. The applicable switch may be a slide switch, a multidirectional input switch, a push switch, or the like.

The manufacturing methods of the first and second embodiments the present invention are described above as manufacturing methods of audio jack connectors. However, the manufacturing methods of the invention are applicable to connectors other than audio jack connectors, jacks, switches, or the like. Moreover, in the case where the body is made of a single part, the manufacturing methods can be modified to include filling the oil into the gaps by immersing the body and the contacts in the oil, or by applying the oil to the gaps between the body and the fixed portions of the contacts. Alternatively, the entire electronic component may be immersed in the oil. The oil used for the manufacturing method of the invention may be non-volatile oil of any kind. More particularly, it is possible to use oil having a contact angle of 90° or larger and a viscosity of 100 cSt or higher, or oil having a contact angle of 90° or smaller and a viscosity of 100 cSt or lower, or oil having a contact angle of 90° or smaller and a viscosity of 100 cSt or higher.

It should be noted that the materials, the shapes, the size, the numbers, and the arrangements of the components of the electronic components described above are described by way of example only. The electronic components may be modified in any manner as long as they provide similar functions. The invention requires at least one contact and at least one first sealant. Accordingly, the invention requires at least one gap between the fixed portion of the contact and the body, and the first sealant may be filled in the gap.

### REFERENCE SIGNS LIST

100: body
100a: first body (part)
   110a: connection hole
   121a: first fitting hole
   122a: second fitting hole
   131a: housing groove
   132a: housing groove
   133a: housing groove
   134a: housing groove
   135a: housing groove
   136a: housing groove
   141a: housing hole
   142a: housing hole
   143a: housing hole
   144a: housing hole
100b: second body (part)
   110b: fitting portion
   120b: projection
100c: third body (part)
   110c: fitting recess

200a-200e: contact
210a-210e: first fixed portion
220a-220e: second fitting portion
230a-230e: contacting portion
240a-240e: tail portion
300a, 300a′: first sealant
300b, 300b′: second sealant

S1-S4: gap

1. An electronic component comprising:
a body having insulation properties;
a contact including a fixed portion held by the body and a tail portion projecting out from the body; and
a first sealant including non-volatile oil filled in a gap between the fixed portion of the contact and the body.

2. The electronic component according to claim 1, wherein
the body includes:
a first body; and
a second body fixed to the first body,
the fixed portion of the contact is held by at least the second body,
the tail portion of the contact projects out from the second body, and
the electronic component further comprises a second sealant including non-volatile oil, the second sealant being filled in a gap between the first and second bodies.

3. The electronic component according to claim 1, wherein
the body includes:
a first body having a connection hole, a first fitting hole communicating with the connection hole, and a second fitting hole communicating between the first fitting hole and an outside of the first body, the second fitting hole being larger or smaller in size than the first fitting hole;
a second body of an outer shape conforming to a shape of the first fitting hole of the first body, the second body fitting in the first fitting hole; and
a third body of an outer shape conforming to a shape of the second fitting hole of the first body, the third body fitting in the second fitting hole,
the fixed portion of the contact is held by at least the second and third bodies,
the tail portion of the contact projects from the third body, and
the electronic component further comprises a second sealant including non-volatile oil, the second sealant being filled in at least a gap between the first and third bodies.

4. The electronic component according to claim 1, wherein the first sealant has a contact angle of 90° or larger.

5. The electronic component according to claim 2, wherein the second sealant has a contact angle of 90° or larger.

6. The electronic component according to claim 1, wherein the first sealant has a viscosity of 100 cSt or lower.

7. The electronic component according to claim 2, wherein the second sealant has a viscosity of 100 cSt or lower.

8. The electronic component according to claim 3,
wherein the second body includes a fitting portion fitting in the first fitting hole and a projection projecting from the first fitting hole, and
the third body includes a fitting recess fitting over the projection of the second body.

9. A method of manufacturing an electronic component comprising:
preparing a body having insulation properties and a contact, the contact including a fixed portion held by the body and a tail portion projecting from the body; and
immersing the body and the contact in non-volatile oil and thereby filling the oil into a gap between the fixed portion of the contact and the body.

10. The method according to claim 9, wherein
the body includes a plurality of parts fixed to one another, and
the method further comprises filling the oil also into a gap between the parts when immersing the body and the contact in the oil.

11. A method of manufacturing an electronic component comprising:
preparing a body having insulation properties and a contact, the contact including a fixed portion held by the body and a tail portion projecting from the body; and
applying non-volatile oil to a gap between the body and the fixed portion of the contact and thereby filling the oil into the gap.

12. The method according to claim 11, wherein
the body includes a plurality of parts fixed to one another, and
the method further comprises applying the oil to a gap between the parts and thereby filling the oil into the gap between the parts before or after applying the oil to the gap between the body and the fixed portion of the contact.

13. The method according to claim 9, wherein the oil has a contact angle of 90° or larger.

14. The method according to claim 11, wherein the oil has a contact angle of 90° or larger.

15. The method according to claim 9, wherein the oil has a viscosity of 100 cSt or lower.

16. The method according to claim 11, wherein the oil has a viscosity of 100 cSt or lower.

17. The method according to claim 9, further comprising:
heating or drying the electronic component after filling the oil into the gap.

18. The method according to claim 10, further comprising:
heating or drying the electronic component after filling the oil into the gaps.

19. The method according to claim 11, further comprising:
heating or drying the electronic component after filling the oil into the gap.

20. The method according to claim 12, further comprising:
heating or drying the electronic component after filling the oil into the gaps.
